(19) United States
(12) Patent Application Publication
(10) Pub. No.: US 2008/0027935 A1
(43) Pub. Date: Jan. 31, 2008

(54) ANCHORED SEARCH ENGINE RESULTS DISPLAY

(76) Inventors: Sahar Sarid, Pompano Beach, FL (US); Kishore Bhavnanie, Bethlehem, PA (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(21) Appl. No.: 11/829,771

(22) Filed: Jul. 27, 2007

Related U.S. Application Data
(63) Continuation-in-part of application No. 11/428,168, filed on Jun. 30, 2006.
Application No. 11/428,168 is a continuation-in-part of application No. 11/291,608, filed on Nov. 30, 2005.

(51) Int. Cl. G06F 7/04

(52) U.S. Cl. 707/6; 707/E17.008

(57) ABSTRACT

A system and method dynamically present a portion of web content including a set of searched for keywords to a user. The system displays a set of search results to a user, wherein the set of search results are associated with at least one search keyword provided by the user, and wherein each search result in the set of search results is associated with a search target. The system then receives, from the user, a selection of one of the search results. The system then presents, in response to receiving the selection, the search target associated with the selected search result at a portion of the search target including the at least one search keyword.

### CROSS REFERENCE TO RELATED APPLICATION

This application is a Continuation-In-Part of co-pending and commonly owned U.S. patent application Ser. No. 11/428,168 entitled “KEYWORD DRIVEN SEARCH FOR QUESTIONS IN SEARCH TARGETS” filed on Jun. 30, 2006, which is a Continuation-In-Part of co-pending and commonly owned U.S. patent application Ser. No. 11/291,608 entitled “METHOD AND SYSTEM FOR PERFORMING A SEARCH FOR QUESTIONS RELATED TO KEYWORDS” filed on Nov. 30, 2005, the entire collective teachings thereof being hereby incorporated by reference.

### FIELD OF THE INVENTION

The present invention generally relates to the field of data searching tools, and more particularly relates to user interfaces for presenting to a user the results of a search.

### BACKGROUND OF THE INVENTION

The amount of information stored across networks has greatly increased over the past few years. For example, the World Wide Web has grown into a vast collection of information comprising billions of web pages. One way of searching for information across a network is by using searching tools. One example of a searching tool is an Internet search engine. Search engines typically are programs that appear to search a network such as the World Wide Web or local intranets for specified keywords and return a list of links to web-pages or files where the keywords are found. Although, current search tools such as Internet search engines are useful for finding information across one or more networks, they are not without their drawbacks.

Current Internet search engines return results that include one or more of the keywords entered by a user. These Internet search engines return results based on data that the search engine has indexed. Indexing occurs when the search engine stores information about web-pages that was retrieved by a web crawler. The contents of each page are then analyzed to determine how it should be indexed. For example, words are extracted from the titles, headings, or special fields called meta tags. Data about web pages is stored in an indexed database for use in later queries.

However, individuals looking for questions or other information associated with the keywords have to sort through the results returned by the search engine to find the questions or other information. For example, a student looking for research topics on a subject has to sort through hundreds if not thousands of web pages to find questions specific to entered keywords. This is because current search engines do not search for questions related to keywords.

Another problem with current search engines is that when a user selects a search result the top of the web page is displayed. A user has to search through the web page to locate the searched for terms. This can become very tedious for large web pages that include vast amounts of information.

Therefore, a need exists to overcome the problems with the prior art as discussed above.

### SUMMARY OF THE INVENTION

Briefly, in accordance with embodiments of the present invention, disclosed are a system and a method for dynamically presenting a portion of web content including a set of searched for keywords to a user by: displaying a set of search results to a user, wherein the set of search results is associated with at least one search keyword provided by the user, and wherein each search result in the set of search results is associated with a search target; receiving, from the user, a selection of one of the search results; and presenting, in response to receiving the selection, the search target associated with the selected search result at a portion of the search target comprising the at least one search keyword.

One advantage of the present invention is that a portion of a web page comprising searched for terms is dynamically presented to a user reducing manual labor and time delays for the user in locating the particular portion of the web page. For example, a user can be displayed a list of search results based on entered search keywords. When the user selects a search result the corresponding web page is presented to the user at the portion of the web page comprising the searched for terms. Therefore, a user does not have to search through the corresponding web page for the desired searched terms.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram illustrating an exemplary network system according to an embodiment of the present invention;

FIG. 2 is a block diagram illustrating an example of a search server according to an embodiment of the present invention;

FIG. 3 is a screenshot of an example of a search engine user interface according to an embodiment of the present invention;

FIG. 4 is a screenshot of an example of the search engine user interface of FIG. 3 according to another embodiment of the present invention;

FIG. 5 is an operational flow diagram illustrating an overall process of performing a network search for questions according to an embodiment of the present invention;

FIG. 6 is an operational flow diagram illustrating an example of a process of identifying questions in a source target that are related to keywords according to an embodiment of the present invention;

FIG. 7 is an operational flow diagram illustrating an example of a process of determining the relevancy of a question when only one keyword is provided by a user according to an embodiment of the present invention;

FIG. 8 is an operational flow diagram illustrating an example of a process of determining the relevancy of a question when a plurality of keywords is provided by a user according to an embodiment of the present invention;

FIG. 9 is an operational flow diagram illustrating an example of a process for returning a list of questions to a user according to an embodiment of the present invention;

FIG. 10 illustrates another embodiment of a search engine user interface according to the present invention;

FIG. 11 is an operational flow diagram illustrating an overall process of performing a network search for news story articles comprising questions related to keyword(s) entered by a user according to an embodiment of the present invention;

FIG. 12 is a block diagram illustrating an anchored search result wherein a portion of a web page comprising searched for terms is presented to a user according to an embodiment of the present invention; and

FIG. 13 is an operational flow diagram illustrating an overall process of presenting a portion of a web page to a user that comprises searched for terms according to an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The present invention, according to an embodiment, overcomes problems with the prior art by providing a means for a user to search for questions or other information associated with keywords over a network such as the Internet. There is a wealth of information on the Internet, such as in a Frequently Asked Question (FAQ) format, or in discussion groups and in bulletin boards in which participants have posted questions and answers. A user seeking an answer to a specific question, which might involve ambiguous keyword results and require significant post-search analysis to find the answer, could search for their question, rather than keywords, as the answer to the question may involve words and phrases unknown to the user.

Further, the tedious task of sorting through web page results to find questions related to keywords is eliminated. A user can enter keywords into a question search engine and have a list of questions associated with those keywords returned back. Another advantage of one embodiment of the present invention is that the list of questions returned to the user is sorted by relevance, thereby increasing the likelihood of the user finding more relevant questions in the least amount of time. Another advantage is that based on the entered keywords, a list of news stories including questions associated with the keywords can be displayed to the user. In one embodiment, the most relevant question associated with the user's entered keywords can be displayed as the headline of the news story. This allows a user to select a news story that is more relevant to the entered keyword(s).

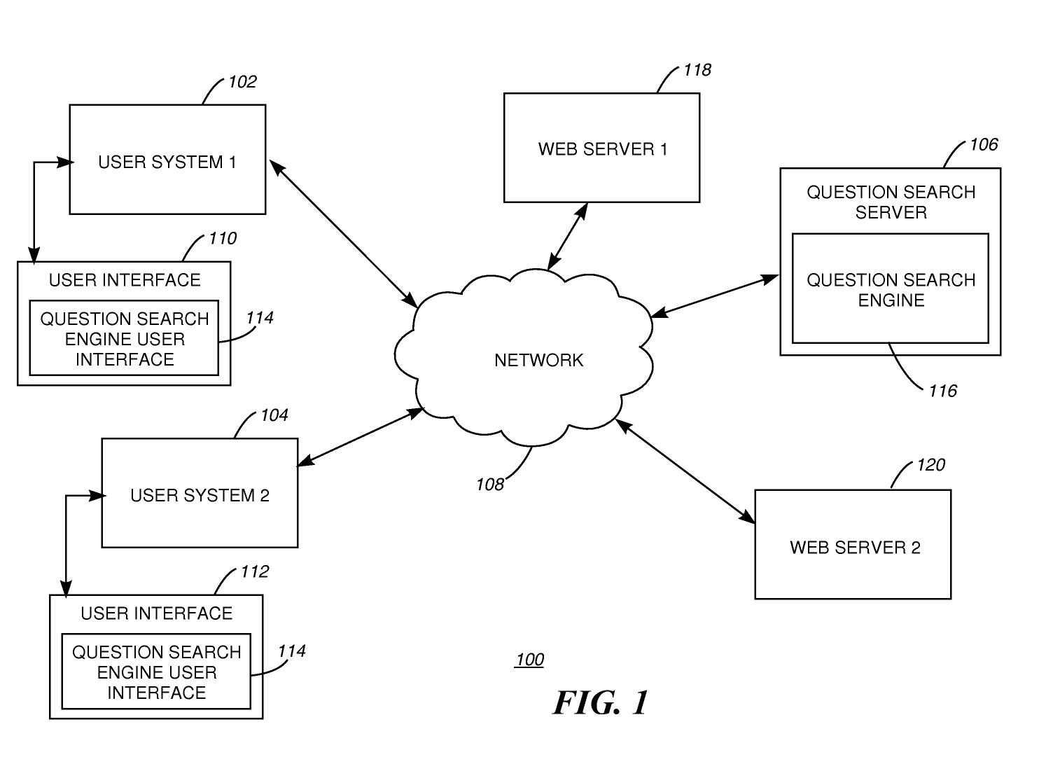

According to one embodiment of the present invention, as shown in FIG. 1, an exemplary system 100 is illustrated. FIG. 1 shows a system 100 comprising a user system1 102 and a user system2 104. User system1 102 and user system2 104 communicate with a question search server 106 through a network 108. The user systems 102, 104, in one embodiment, are personal computers, notebook computers, workstations, PDAs, cellular phones capable of browsing the Internet, and the like. The network 108, according to one embodiment, comprises a LAN, WAN, World Wide Web, wireless network, and the like. User system1 102 and user system2 104, for example, are communicating with the question search server 106 to search for questions on the network 108 relating to keywords provided by the user. The term “question” is defined as an interrogative sentence, or text string, that may be identified by, for example, the presence of a question mark at the end and/or the presence of an interrogative word such as “who”, “what”, “when”, “where”, and “why” at the beginning of the sentence.

Other different aspects of an interrogative sentence or text string can be used to determine whether the interrogative sentence or text string linguistically represents a question, in accordance with the present invention. For example, the syntax, context, and meaning of words in an interrogative sentence, text string, or the like, with respect to a particular language, may represent a question according to the present invention. Additionally, a rhetorical statement that does not end with a question mark may nonetheless constitute a question. The words “to be or not to be, that is the question”, for example, may be considered to express a question. User system1 102 and user system2 104 are communicatively coupled to a user interface 110, 112, for example a display, so that a user can interact with a question search engine user interface 114 provided by the question search engine server 106. The question search engine user interface 114 allows the user to interact with the question search engine 106 to search for questions related to search keywords. The question search engine user interface 114 will be discussed in greater detail below.

The question search server 106 includes a question search engine 116, which will be discussed in greater detail below. The question search server 106 communicates with one or more web servers such as web server1 118 and web server2 120. The web servers 118, 120, for example, are servers such as a Google, a MSN, or a Yahoo server used to search the Internet for information. In another embodiment, the web servers 118, 120 can be news servers including news related information. In one embodiment, the question search server 106 receives one or more search keywords from a user through the question search engine user interface 114. The question search server 106 then queries the web servers 118, 120, for example, by using an API associated with the web server 118, 120 to obtain search targets where the search keywords are found. Search targets, for example, are a title of a web page, a description of a web page, a summary of a web page, contents of a website, contents of a web page, news articles, and the like.

The question search server 106 analyzes the search targets to identify questions related to the entered search keywords. The identified questions are transmitted and displayed to the user, for example, through the question search engine user interface 114. In another embodiment, the question search server 106 searches news stories to locate news stories that include questions associated with the entered keywords. A list of news stories including questions related to the keywords can then be presented to the user. In one embodiment, each headline in the list of news stories comprises a question that is associated with the entered keywords. The question search server 106 will be discussed in greater detail below.

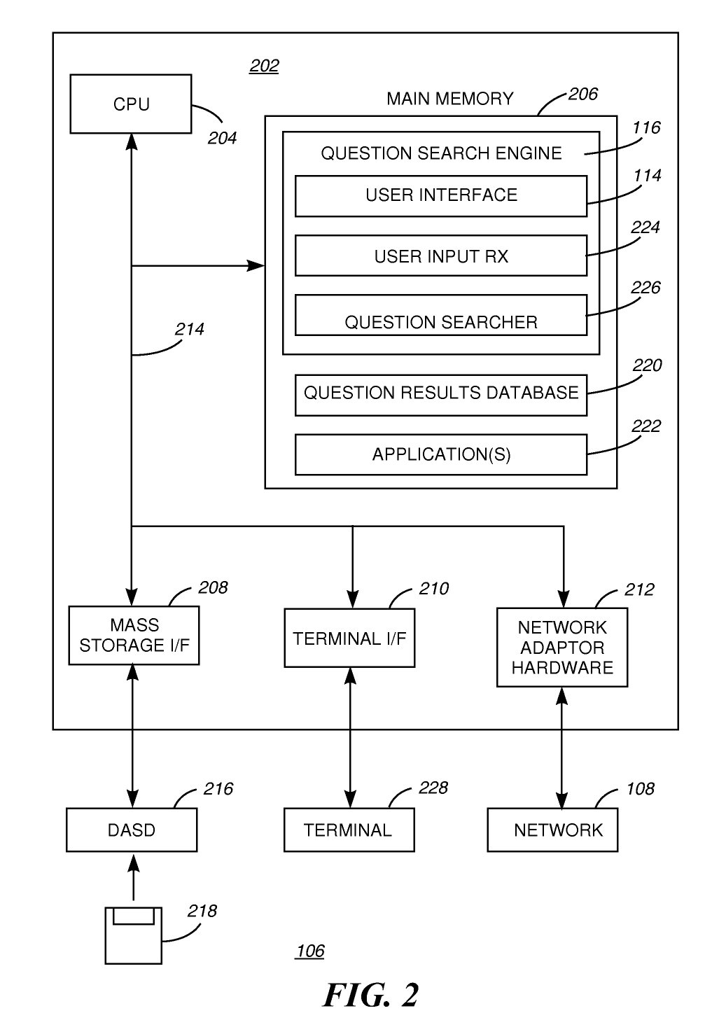

FIG. 2 is a block diagram illustrating a more detailed view of the question search server 106 according to an embodiment of the present invention. The question search server 106 is based upon a suitably configured information processing system adapted to implement the exemplary embodiment of the present invention. Any suitably configured information processing system is similarly able to be used as the question search server 106 by certain embodiments of the present invention, for example, a personal computer, workstation, or the like.

The question search server 106 includes a computer 202. The computer 202 has a processor 204 that is connected to a main memory 206, a mass storage interface 208, a terminal interface 210, and a network adapter hardware 212. A system bus 214 interconnects these system components. Mass storage interface 208 is used to connect mass storage devices, such as a data storage device 216, to the question search server 106. One specific type of data storage device is a floppy disk drive, which may be used to store data to and read data from a floppy diskette 218, which contains a signal bearing medium. Another type of data storage device is a data storage device configured to support NTFS type file system operations.

The program memory 206 comprises the question search engine 116, a questions results database 220, and one or more application(s) 222. In one embodiment, the question search engine 116 includes the question search engine user interface 114, a user input receiver 224 and a question searcher 226. The question search engine user interface 114 allows a user to interact with the question search engine 116. The question search engine user interface 114 will be discussed in greater detail below. The user input receiver 224 receives the keyword or search keywords entered into the question search engine user interface 114. The search keywords are used by the question searcher 226 to search for questions that are associated with the search keywords over a network such as the Internet.

For example, the question searcher 226 uses an API (not shown) associated with the web servers 118, 120 (FIG. 1) to retrieve search targets including the search keywords. The question searcher 226 then analyzes the one or more search targets for questions related to the search keywords. The search targets, in one embodiment, are temporarily stored in the main memory 206 while the question searcher 226 analyzes the search targets. In one embodiment, when a question related to the search keywords is found, the question, associated keyword(s), and information regarding the search target that includes the question are stored in the question results database 220. In one embodiment, the question search engine 116 compiles a list of questions related to the keyword(s) that are to be displayed to the user through the question search engine user interface 114. In another embodiment, the list of questions also includes links to the web pages, articles, and the like that include a respective question in the list.

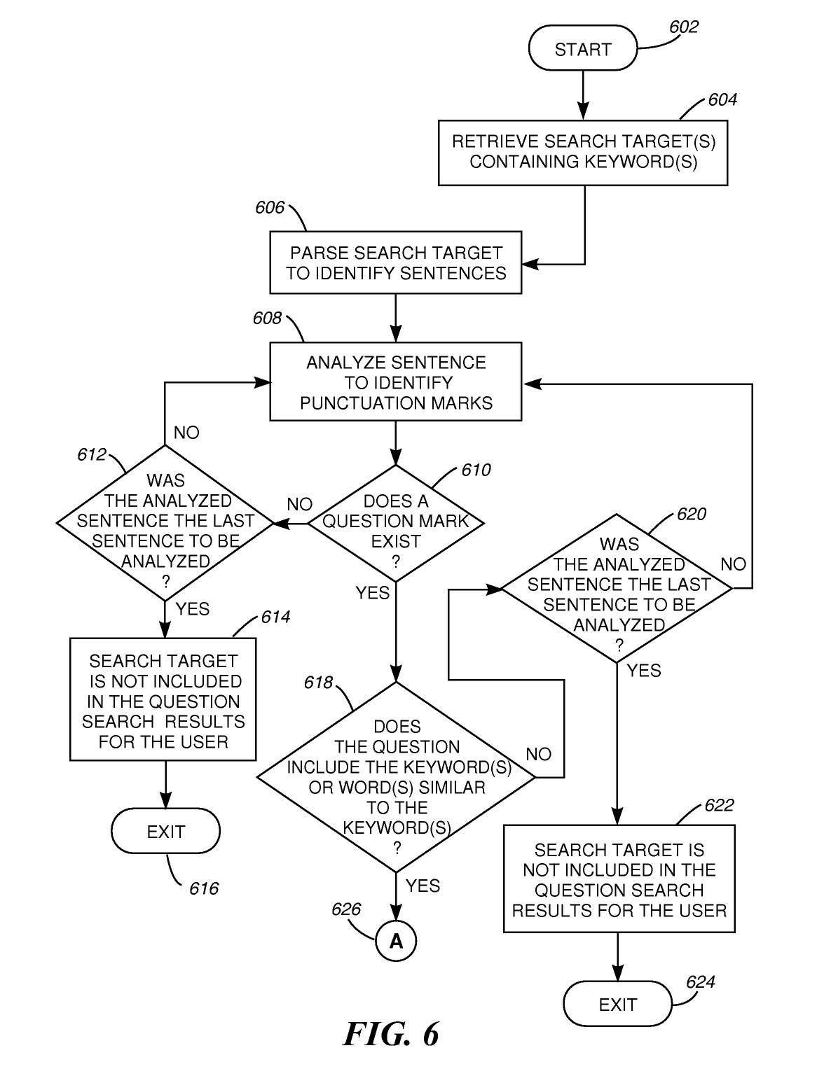

In one embodiment, the question search engine 116 compiles a list of news stories that include one or more questions related to the keyword(s) that are to be displayed to the user through the question search engine user interface 114. The question searcher 226 searches news stories to identify questions within each of the news stories. The question searcher 226 then analyzes each question to determine if a question is relevant to the entered keyword. The question searching and analyzing procedures are further discussed in FIGS. 6-9. In one embodiment, each of the news stories that include a question associated with the keywords is displayed to the user with a headline. The headline, in one embodiment, comprises a questions associated with the keyword. In one embodiment, the most relevant question is presented as the headline of the news story, but the present invention is not limited to selecting a headline in this manner.

In one embodiment, the questions and their associated links are retained in the database 220 for future searches. In another embodiment, the question results database 220 is periodically updated. For example, the question searcher 226, in one embodiment, automatically searches for new questions to update the questions stored in the question results database 220. The question results database 220, in one embodiment, is initially searched for questions by the question searcher 226. For example, when the user input receiver 224 receives a keyword(s), the question searcher 226 checks the question results database 220 for questions related to the keyword(s). If questions do not exist for the keyword in the question results database 220, the question searcher 226 queries the web servers 118, 120. In another embodiment, the question searcher 226 checks an update log (not shown) to determine when the question results database 220 was last updated. If the update was not completed within a predefined time period, the question searcher 226 queries the web servers 118, 120 for updated questions.

In another embodiment, the questions results database 220 retains the news stories and their links in the database 220 for future searches. A user may want to retain old news stories for archival purposes or can apply optional filters that only retain news stories for a given period of time. The updating procedure discussed above also applies to the embodiment where news stories are retained within the database 220.

The main memory 206 also includes an application(s) 222 that is, for example, running or waiting to be executed. Although illustrated as concurrently resident in the main memory 206, it is clear that respective components of the main memory 206 are not required to be completely resident in the main memory 206 at all times or even at the same time. In one embodiment, the question search server 106 utilizes conventional virtual addressing mechanisms to allow programs to behave as if they have access to a large, single storage entity, referred to herein as a computer system memory, instead of access to multiple, smaller storage entities such as the main memory 206 and data storage device 216. Note that the term “computer system memory” is used herein to generically refer to the entire virtual memory of the question search server 106

Although only one CPU 204 is illustrated for the computer 202, computer systems with multiple CPUs can be used equally effectively. Embodiments of the present invention further incorporate interfaces that each includes separate, fully programmed microprocessors that are used to off-load processing from the CPU 204. Terminal interface 210, according to one embodiment, is used to directly connect one or more terminals 228 to computer 202 to provide a user interface to the question search server 106. These terminals 228, which are able to be non-intelligent or fully programmable workstations, are used to allow system administrators and users to communicate with the question search server 106. The terminal 228 is also able to consist of user interface and peripheral devices that are connected to computer 202 and controlled by terminal interface hardware included in the terminal I/F 210 that includes video adapters and interfaces for keyboards, pointing devices, mp3 players, PDA docking stations, and the like.

An operating system (not shown) is also included in the main memory 206 and is a suitable multitasking operating system such as the Windows XP or Windows Server 2003 operating system. Embodiments of the present invention are able to use any other suitable operating system. Some embodiments of the present invention utilize architectures, such as an object oriented framework mechanism, that allows instructions of the components of operating system (not shown) to be executed on any processor located within the question search server 106 or in an alternative embodiment, the user systems 102, 104.

The network adapter hardware 212 is used to provide an interface to the network 108. Embodiments of the present invention are able to be adapted to work with any data communications connections including present day analog and/or digital techniques and/or via any networking mechanism such as wired, wireless, local area, and wide area networks, and any other types of networks and communications links as should be obvious to those of ordinary skill in the art in view of the present discussion.

Although the exemplary embodiments of the present invention are described in the context of a fully functional computer system, those skilled in the art will appreciate that embodiments are capable of being distributed as a program product via floppy disk, e.g. floppy disk 218, CD ROM, or other form of recordable media, or via any type of electronic transmission mechanism.

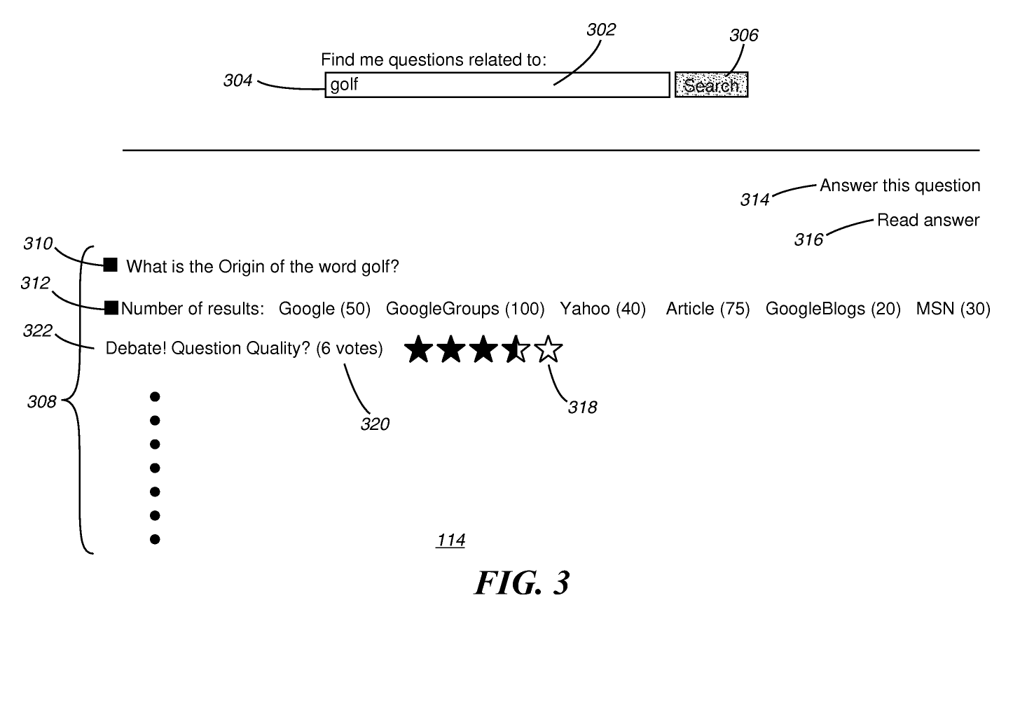

FIG. 3 shows a detailed view of a question search engine user interface 114 according to one embodiment of the present invention. It is noted the question search engine user interface 114 illustrated in FIG. 3 is only an example and alternative embodiments and may include or not include one or more additional objects. The question search engine user interface 114 allows a user to enter search keywords and have the question search server 106 return a list of questions related to those search keywords back to the user. The question search engine user interface 114, in one embodiment, also allows the user to view the answers to the listed questions.

The question search engine user interface 114 includes a search box 302. The search box 302 allows a user to enter one or more search keywords for searching. For example, FIG. 3 shows that search keyword 304 “golf” has been entered in to the search box 302. A search button 306 is also included that allows the user to initiate the question search for the entered search keywords. After the search is completed a list of questions 308 related to the keyword(s) 304 is displayed to the user. For example, a question 310 “What is the Origin of the Word Golf?” is displayed to the user. The question search engine user interface 114 also includes a result type section 312 for each question that displays the number and the type of search targets that include the respective question. For example, the question search server 106 located 50 results on Google, 100 results in GoogleGroups, 40 results on Yahoo, 75 results in various articles, 20 results in GoogleBlogs, and 30 results on MSN.

In one embodiment, a user can answer the question by clicking on a button or a link such as the “Answer this question” link 314. Additionally, the user can also read an answer to a question provided by other users by clicking on a button or link such as the “Read answer” link 316. A question quality bar 318 is also provided, in one embodiment, for allowing a user to rate the question 310. For example, if a user found the question 310 helpful or relevant to the entered keyword 306, the user can select a higher rating for the question 310. FIG. 3 shows the rating as being displayed on a scale of one to five stars, where five stars is the best rating possible and one star is the lowest rating possible. However, any rating system is able to be used. Also, the number 320 of users who have rated the question is also displayed.

Additionally, users of the question search engine user interface 114, in one embodiment, are able to debate other users on the answers to the question. For example, a button or a link such as the “Debate!” link 322 allows a user to enter into a debate area where users can post their thoughts and answers to the associated question and reply to other users' thoughts and answers. The list of questions 308, in one embodiment, is sorted by relevancy. For example, the question search engine 116 analyzes the questions and places the question it determines to be the most relevant to the entered keyword(s) at the beginning of the list. The question search engine user interface 114, in one embodiment, provides a means for a user to resort the list based on, for example, highest relevancy, lowest relevancy, highest rating, lowest rating, and the like. It is noted that the list can be sorted in any order and is not limited to being sorted by relevancy.

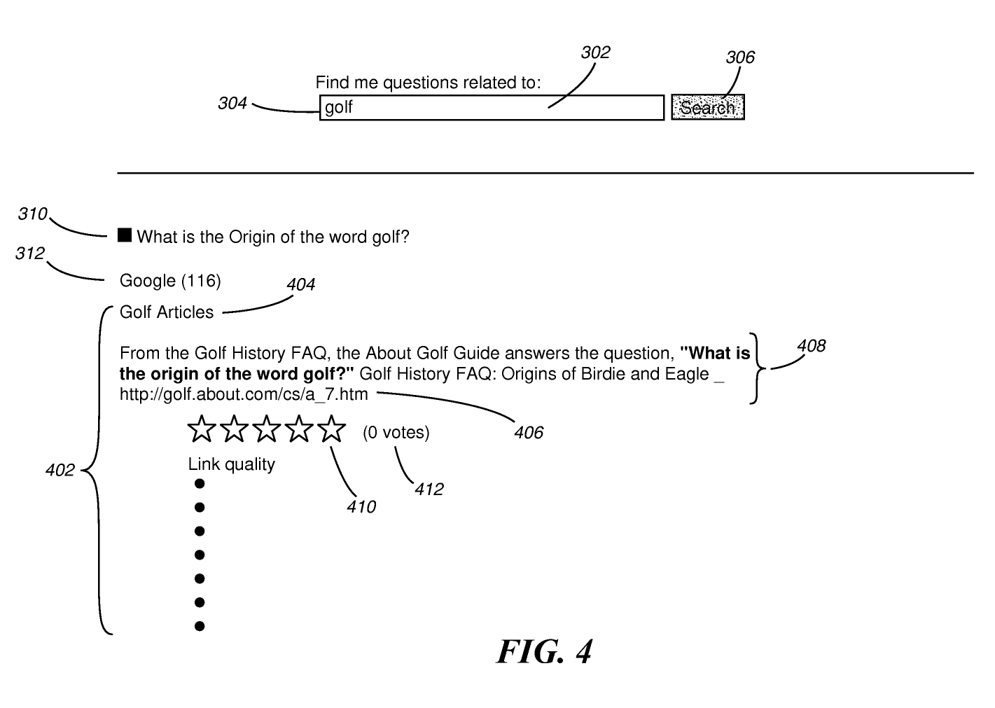

FIG. 4 shows a detailed view of the question search engine user interface 114 according to another embodiment of the present invention. It is noted that the question search engine user interface 114, in other embodiments, can include additional elements not shown in FIG. 4. FIG. 4 shows the question search engine user interface 114 after a question has been selected by a user. For example, the user entered the search keyword 304 “golf” into the search field box 302, initiated the search with the search button 306, and selected the question 310 “What is the Origin of the Word Golf?”

After the user selects a question such as question 310, a list 402 is displayed with links to location of the question. For example, a link 404 to a web page having an article that includes the question 310 is provided to the user. The link 404, in this embodiment, is a hyperlink that is also the title of the web page. The URL 406 of the web page is also provided to the user in one embodiment. A description/summary 408 of the web page is also included. A link quality bar 410 is provided for the user to rate the quality of the link. For example, if the user found the link 404 to be helpful to answer the question 310, the user can give the link 404 a high quality link rating. FIG. 4 shows the rating as being displayed on a scale of one to five stars, where five stars is the best rating possible and one star is the lowest rating possible. However, any rating system is able to be used. Also, the number of users 412 who have rated the link is also displayed. The list of links 402, in one embodiment, is sorted by how relevant the links are to the questions 310. In an alternative embodiment, the list of links 404 is sorted by link quality rating. However, the sorting of the list of links 402 is not limited to these methods of sorting.

In one embodiment, the list of links 402 is provided to the user after the user selects a specific category of search results. For example, the list of links 402 is provided to the user after the user selects the Google results 312. The list of links 402, in this embodiment, are links to results found by the question searcher 226 using a Google search engine.

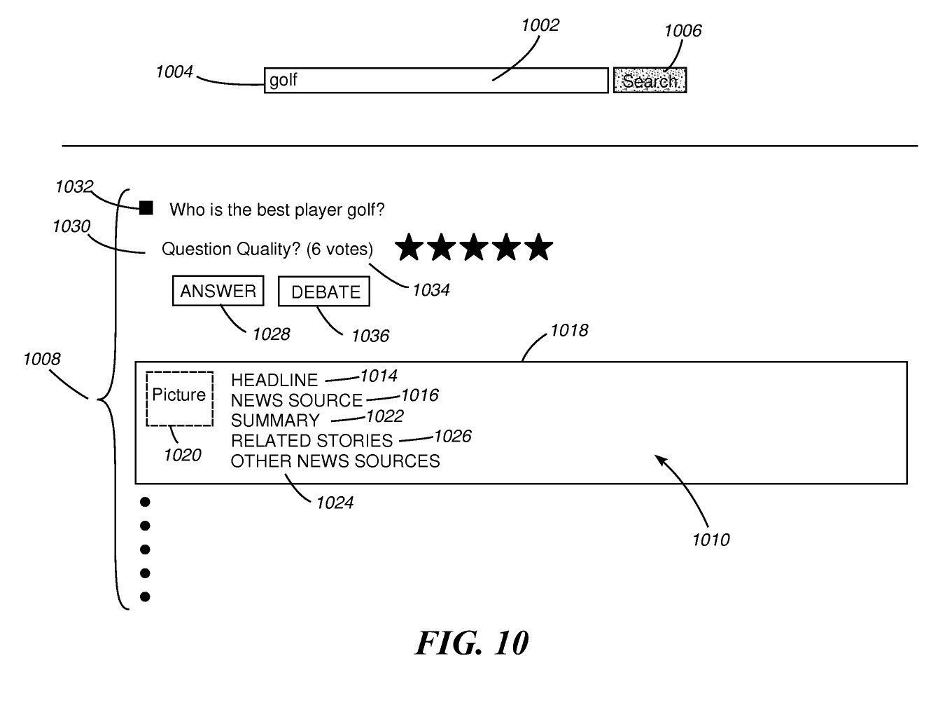

FIG. 10 shows another embodiment of the detailed view of the question search engine user interface 114. FIG. 10 shows the search engine user interface 114 being used for searching news stories including questions associated with entered keywords. It is noted the question search engine user interface 114 illustrated in FIG. 10 is only one example and alternative embodiments may include or not include one or more additional objects. The question search engine user interface 114 allows a user to enter search keywords and have the question search server 106 return a list (to the user) of news stories including questions related to those search keywords. The question search engine user interface 114, in one embodiment, also allows the user to view the answers (e.g., the actual news story, another user's answer to the question, and the like) to one or more of the questions in the news story.

The question search engine user interface 114 includes a search box 1002. The search box 1002 allows a user to enter one or more search keywords for searching. For example, FIG. 10 shows that search keyword 1004 “golf” has been entered in to the search box 1002. A search button 1006 is also included that allows the user to initiate the question search for the entered search keywords. After the search is completed a list of news stories 1008 related to the keyword(s) 1004 is displayed to the user. For each news story, a headline question 1032 is displayed that is associated with the entered keyword(s) 1004. Each news story includes a news story area 1010 that includes information 1012 relating to the news story. For example, the news story area 1010 of a first news story 1018 can include the actual news story headline 1014. The actual headline 1014, in one embodiment can include a hyperlink to the actual site hosting the news story or a separate link (not shown) can be included. The news story related information 1012 can also include the name 1016 of the news source that published the news story. The news source name 1016 can also be a hyperlink to the website of the news source.

The news story area 1010 can also include one or more pictures 1020 associated with the new story 1018. A summary 1022 of the news story 1018 can also be included in the news story area 1010. In one embodiment, the news story area 1010 also includes links 1024 to other news sources carrying the same news story 1018 and links 1026 to related news stories. It should be noted that the present invention is not limited to the configuration just described. The information associated with a news story that is displayed to a user can comprise other components not discussed above.

In one embodiment, the headline question 1032 of the news story 1018 is comprised of one or more questions included in the news story 1018 and that are related to the keywords 1004 entered by the user. In one embodiment, the most relevant question to the keyword 1004 entered is displayed as the headline question 1032 of the news story 1018. However, the headline question 1032 is not limited to the most relevant questions. Furthermore, the arrangement of the news stories within the list of news stories 1018 is not limited to a relevancy prioritization. Other prioritization methods may be used.

In one embodiment, a user can answer a question within the news story, or the headline question 1032, by clicking on a button or a link such as the “Answer this question” link 1028. Additionally, the user can also read an answer to a question provided by other users by clicking on a button or link such as a “Read answer” link (not shown). A question quality bar 1030 is also provided, in one embodiment, for allowing a user to rate the question. For example, if a user found the question helpful or relevant to the entered keyword 1006, the user can select a higher rating for the question. FIG. 10 shows the rating as being displayed on a scale of one to five stars, where five stars is the best rating possible and one star is the lowest rating possible. However, any rating system is able to be used. Also, the number 1034 of users who have rated the question is also displayed.

Additionally, users of the question search engine user interface 114, in one embodiment, are able to debate other users on the answers to the question. For example, a button or a link such as the “Debate” link 1036 allows a user to enter into a debate area where users can post their thoughts and answers to the associated question and reply to other users' thoughts and answers. The list of questions 308, in one embodiment, is sorted by relevancy. The question search engine user interface 114, in one embodiment, provides a means for a user to resort the news story list 1008 based on, for example, highest relevancy, lowest relevancy, highest rating, lowest rating, and the like. It is noted that the list can be sorted in any order and is not limited to being sorted by relevancy.

In another embodiment a list of questions (not shown) included within the news story article 1918 is displayed to the user. For example, the list may include other questions that are relevant to the keywords 1004 entered by the user but not selected as the heading question 1032. In another embodiment, every questions included in the news story article 1018 regardless of relevancy is displayed to the user. The list of questions (not shown) can be provided by a drop-down menu, a link, or the like.

Returning to FIG. 4, another embodiment of the present invention provides an anchored search result display to a user. For example, as discussed above, a user can enter a search keyword 304 such as “golf” into the search field box 304 and a list of questions are displayed that include one or more of the search keywords 304. FIG. 4 shows only a single question 310 with its related search result 402. However, more than one question 310 can be displayed to a user. In one embodiment a description/summary 408 of the web page can be provided. In one example, the question 310 can be highlighted, changed to a bold font, or have any other visual effect performed on it within the description/summary 408.

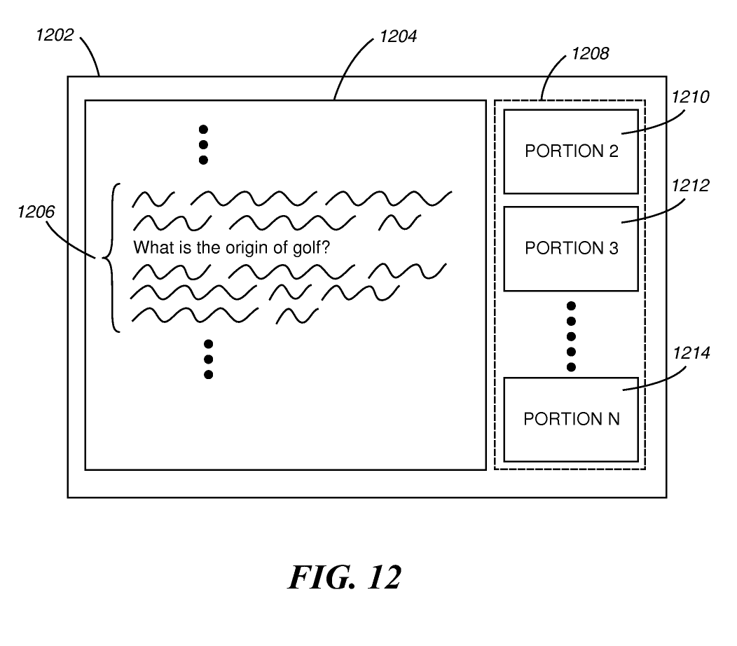

After the user selects the URL 406 of the web page comprising the question 310, the web page is displayed to the user at the portion comprising the question 310. For example, FIG. 12 shows a display 1202 presenting a web page 1204 to a user at a portion 1206 of the web page comprising the question 310. The web page 1204 is dynamically displayed to the user at the portion 1206 of the web page that includes the question 310. In other words, a user does not have to search throughout the web page to locate the searched for items. This provides significant time savings for the user as well as reduced manual labor.

In another embodiment, if additional portions of the web page also include the question 310, an optional navigation bar 1208 can be included on the display 1202. The navigation bar 1208 includes one or more hyperlinks, thumbnails, or the like that when selected take the user to the next portion of the web page 1204 that includes the question 310. For example, FIG. 12 shows a first box 1210 for a second portion, a second box 1212 for a third portion, and another box 1214 for an Nth portion. These boxes 1210, 1212, 1214 can include a thumbnail version of its corresponding portion. When a user clicks on a box such as the first box 1210 for portion 2, the second portion of the web page 1204 comprising the question 310 is presented to the user. It should be noted that the navigation bar 1208 can be placed anywhere on the display 1202. A portion 1206 that is presented can be any given size that is defined by a user or is predefined by a search server 106. Also, a size of the portion that is displayed can be defined based on the resolution of a user's display 1202. For example, a higher resolution of a display may allow a larger size of a portion of information to be displayed.

It should be noted that the above discussion for the anchored search result display is not limited to displaying search results for a question 310. Alternative embodiments of displaying a portion of a web page comprising searched for text are applicable to presenting any text, phrase, or the like. For example, a user can enter one or more keywords in a search engine that returns web page results comprising those keywords. The results do not necessarily have to be questions. In other words, the results can include any combination of text, phrases, questions, or the like.

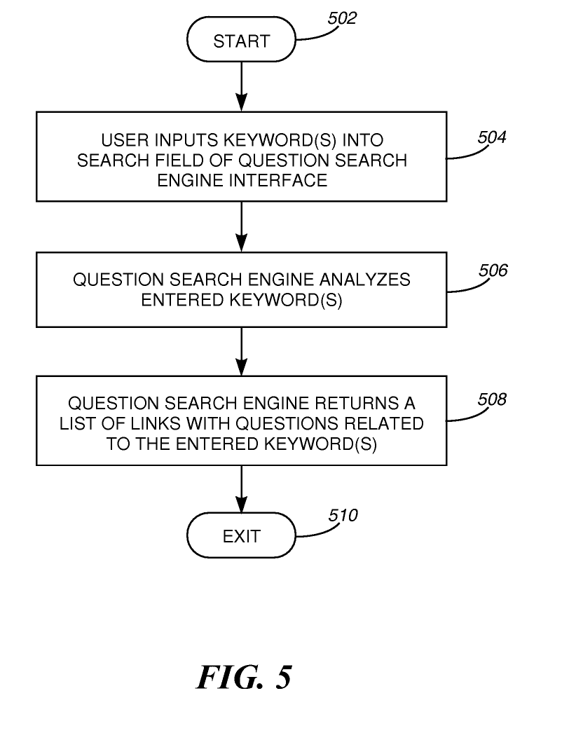

FIG. 5 is an operational flow diagram illustrating one example of a process of a user entering a keyword and the question search server 106 returning a list of questions related to the keyword back to the user. The operational flow diagram of FIG. 5 begins with step 502 and flows directly to step 504. The user, at step 504, inputs one or more search keywords into the question search engine user interface 114. The question search engine 116, at step 506, analyzes the entered search keywords. For example, the question search engine 116, analyzes the entered search keywords to find relevant questions for the keyword(s). The question search engine 116, at step 508, returns a list of questions 308 related to the keyword(s) back to the user with links to network locations, for example, a web page, including the question. The control flow then exits at step 510.

FIG. 6 is an operational flow diagram illustrating one example of a process of identifying questions relating to entered search keywords in a search target. The operational flow diagram of FIG. 6 begins with step 602 and flows directly to step 604. The question search engine 116, at step 604, retrieves search targets that include the search keywords. In another embodiment, the question search engine 116 retrieves search targets that include synonyms of the search keywords. In one embodiment, the search target is a web page, website, title of a web page, description of a web page, a file that is hyperlinked to by a web page, or the like. The question searcher 226, at step 606, parses the search target to identify sentences. For example, the question searcher 226, in one embodiment, looks for at least one blank space after a punctuation mark such as a period, exclamation point, question mark, or the like to identify the beginning of a sentence. The question searcher 226 then looks for a punctuation mark such as a period, exclamation point, question mark, or the like to identify the end of a sentence. Note that in other embodiments the question searcher 226 can analyze many different aspects of a text string, typically in the form of a sentence, to determine whether the text string linguistically represents a question, in accordance with the present invention. For example, the syntax, context, and meaning of words in a sentence, or the like, with respect to a particular language, may represent a question according to the present invention. A rhetorical statement that does not end with a question mark may nonetheless constitute a question. The following words in quotes, as an example, may be considered to express a question—“to be or not to be, that is the question.”

The question searcher 226, at step 608, identifies the punctuation marks and determines, at step 610, if a question mark exists. If the result of this determination is negative, the question search engine 116, at step 612, determines whether the sentence that was just analyzed is the last sentence in the search target. If the result of this determination is negative, the question searcher 226 continues to analyze the next sentence at step 610. If the result of this determination is positive, the question search engine 116, at step, 614, does not include the search target in the results to be displayed to the user. The control flow then exits at step 616.

Continuing with step 610, if the result of this determination is positive, the question searcher 226, at step 618, determines whether the identified question includes the entered keyword(s) or, in one embodiment, similar words such as synonym(s) of the keyword(s). If the result of this determination is negative, the question search engine 116, at step 620, determines whether the sentence that was just analyzed is the last sentence in the search target. If the result of this determination is negative, the question searcher 226 continues to analyze the next sentence at step 610. If the result of this determination is positive, the question search engine 116, at step, 622, does not include the search target in the results to be displayed to the user. The control flow then exits at step 624.

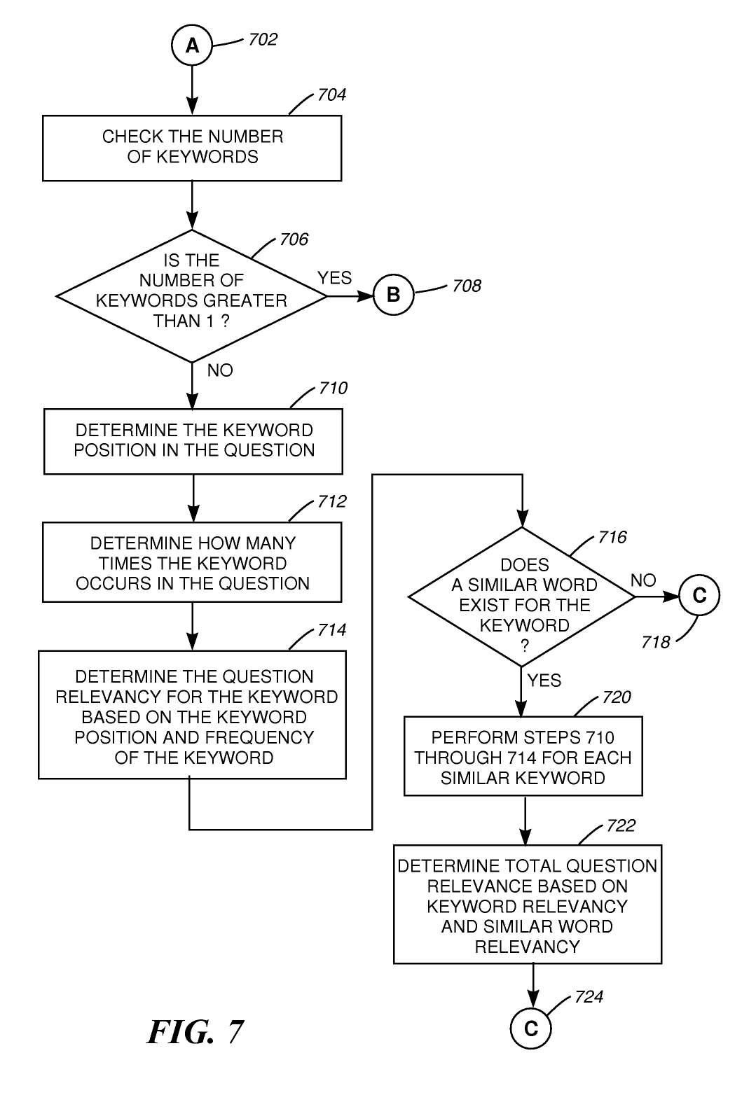

In one embodiment, the questions searcher 226 identifies all the questions in the search target first and then analyzes each question to determine whether the question includes the keyword(s) or similar word(s). If the result of the determination at step 618 is positive, the control flows to entry point A at step 626, which will be discussed in detail with respect to FIG. 7. Although the above discussion for FIG. 6 was with respect to search keywords, in one embodiment, the same process is followed when search targets are retrieved that include synonyms of the search keywords.

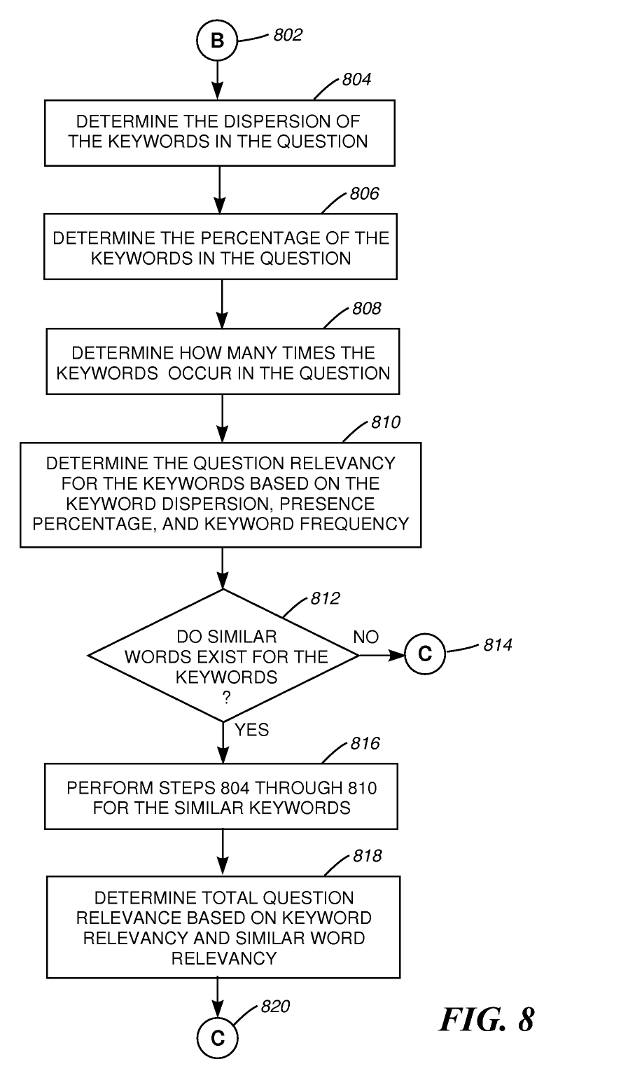

FIG. 7 is an operational flow diagram illustrating an exemplary process of determining the relevancy of a question including a keyword provided by a user. The operational flow diagram of FIG. 7 begins with step 702 and flows directly to step 704. The question search engine 116, at step 704, checks the number of search keywords entered by the user through the question search engine user interface 114. The question search engine 116, at step 706, determines whether the number of search keywords is greater than one. If the result of this determination is positive, the control flows to entry point B at step 708, which will be discussed in more detail with respect to FIG. 8. If the result of this determination is negative, the question search engine 116, at step 710, determines the keyword position in the question. For example, the question search engine 116 in one embodiment, determines how many words from the beginning of the question the keyword is. In another embodiment, the question search engine 116 determines how many words from the end of the question the keyword is.

The question search engine 116, at step, 712, determines the frequency of occurrence for the keyword. For example, the question search engine 116 determines the number of times the keyword occurs in the question. The question search engine 116, at step 714, determines how relevant the question is to the keyword based on the position of the keyword and the number of times it occurred in the question. For example, in one embodiment, a higher number of occurrences in a question makes the question more relevant than a lower number of occurrences. Additionally, in one embodiment, a question having a keyword closer to the beginning or end of the question is likely more relevant than a question having the keyword in the middle of the sentence. In an alternative embodiment, if a question includes interrogative words such as “who”, “what”, “when”, “where”, “why”, and “how” the question is likely more relevant than a question that does not include interrogative words.

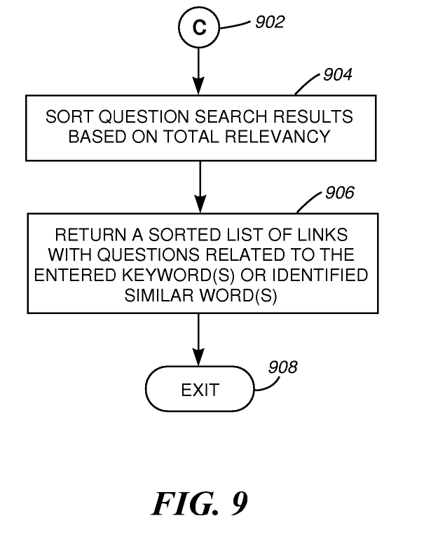

The question search engine 116, at step 716, determines whether a similar word(s) such as a synonym(s) exists for the keyword in the question. If the result of this determination is negative, the control flow at step 718 flows to entry point C, which will be discussed in more detail with respect to FIG. 9. If the result of this determination is positive, the position of the similar word(s) is determined and the number of times the similar word(s) occurs in the question is determined, at step 720. The question search engine 116, at step 722, determines the total relevance for the question based on the keyword relevancy and the similar word relevancy. The control flow at step 724 flows to entry point C, which will be discussed in more detail with respect to FIG. 9.

FIG. 8 is an operational flow diagram illustrating one example of a process of determining the relevancy of a question including a plurality of search keywords provided by a user. The operational flow diagram of FIG. 8 begins with step 802 and flows directly to step 804. The question search engine 116, at step 804, determines how disperse the search keywords are in the question. For example, the question search engine 116 determines if the search keywords entered by the user are included in the question in the same order as how the user entered them. In one embodiment, the question search engine 116 removes articles such as “a”, “the”, and the like when making the dispersion determination. The question search engine 116, at step 806, determines the percentage of the search keywords in the question. For example, the question may include one or more of the search keywords provided by the user.

The question search engine 116, at step, 808, determines the frequency of occurrence for the keyword. For example, the question search engine 116 determines the number of times the keyword occurs in the question. The question search engine 116, at step 714, determines how relevant the question is to the keyword based on the dispersion of the search keywords, presence percentage, and the number of times the search keywords occurred in the question. For example, in one embodiment, a higher relevancy is given to a question that has less dispersion of search keywords. Also, in another one embodiment, a higher relevancy is given for a higher percentage of search keywords existing in the question. Additionally, in one embodiment, a question having a greater occurrence of the search keywords also results in a higher relevance.

The question search engine 116, at step 812, determines whether a similar word(s) such as a synonym(s) exists for each keyword in the question. If the result of this determination is negative, the control flow at step 814 flows to entry point C, which will be discussed in more detail with respect to FIG. 9. If the result of this determination is positive, the dispersion, presence percentage, and frequency of occurrence of the similar word(s) in the question are determined, at step 816. The question search engine 116, at step 818, determines the total relevance for the question based on the keyword relevancy and the similar word relevancy. The control flow at step 820 flows to entry point C, which will be discussed in more detail with respect to FIG. 9.

FIG. 9 is an operational flow diagram illustrating one example of a process of providing the list of questions 308 to a user. The operational flow diagram of FIG. 9 begins with step 902 and flows directly to step 904. The question search engine 116, at step 904, sorts the list of questions 308 based on the total relevancy of each question. For example, the question search engine 116, in one embodiment, sorts the list 308 with the most relevant question at the top of the list and the least relevant question at the bottom of the list. In one embodiment, the question search engine user interface 114 provides a means such as a button or a link to resort the list based on other sorting methods such as ascending order of relevancy.

The question search engine 116, at step 906, returns a sorted list 308 of questions to the user that include the entered keyword(s) or words that are similar to the entered keyword(s). The list of questions 308 is displayed to the user through the question search engine user interface 114. The list of questions 308, in one embodiment, also includes links to web pages, articles, and the like that include the respective question. A user is able to click on the link and read the web page, article, or the like that includes the question. Additionally, by presenting search results to the user by anchored search result display inside a particular found web page, for example, the user does not have to search throughout the web page to locate the searched for items. This provides significant time savings for the user as well as reduced manual labor. The control flow then exits at step 908.

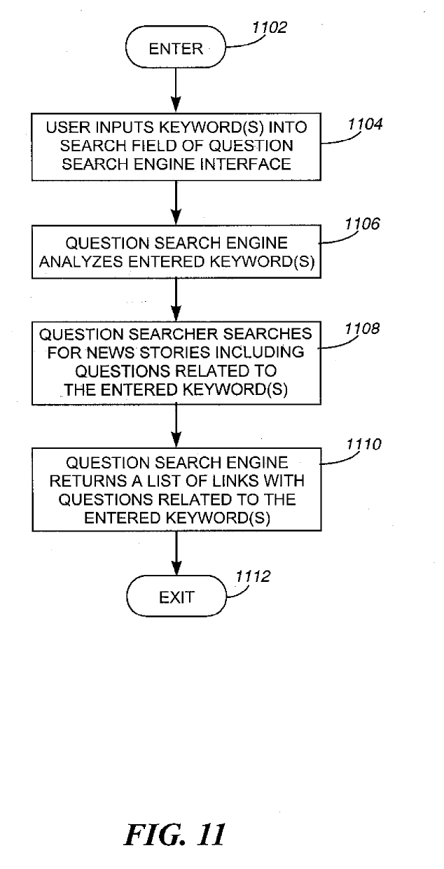

FIG. 11 is an operational flow diagram illustrating one example of a process of returning a list of news stories including questions related to entered keywords to user. The operational flow diagram of FIG. 11 begins with step 1102 and flows directly to step 1104. The user, at step 1104, inputs one or more search keywords into the question search engine user interface 114. The question search engine 116, at step 1106, analyzes the entered search keywords. The question search engine 116, at step 1108, searches news sources for news story articles comprising questions related to the keyword(s) entered by the user. The searching process is discussed above with respect to FIGS. 6-9. The question search engine 116, at step 1110, returns a list of news stories related to the keyword(s) back to the user with links to network locations, for example, a web page, including the question. In one embodiment, each news story in the list of news stories includes a headline question comprising a question from the news story that is associated with the keyword(s) entered by the user. The control flow then exits at step 1112.

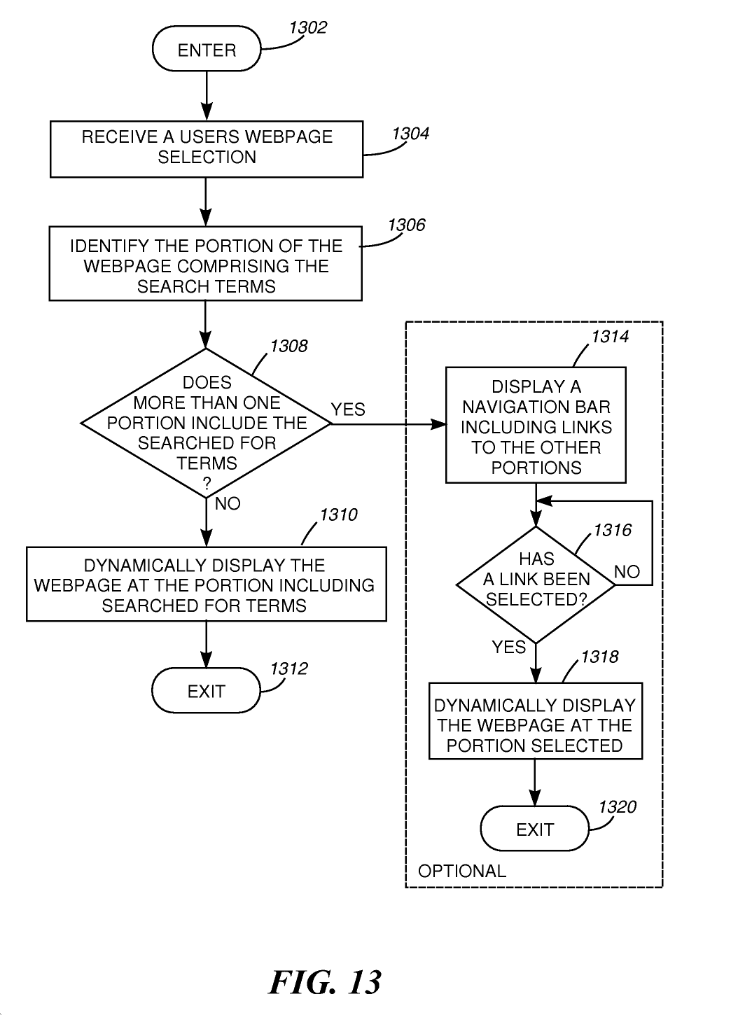

FIG. 13 is an operational flow diagram illustrating one example of a process dynamically presenting a web page to a user at a portion of the web page comprising searched for terms. The operational flow diagram of FIG. 13 begins with step 1302 and flows directly to step 1304. The search server 106, at step 1304, receives a user's selection for a web page 1204 from a list of search results. The search server 106, at step 1306, identifies the portion(s) 1206 of the web page 1204 that include searched for terms 304. The search server 106, at step 1308, determines if more than one portion 1206 has been identified. If the result of the determination is negative, the search server 106, at step 1310, dynamically presents the web page 1204 to the user at the portion 1206 including the searched for terms 304. The control flow then exits at step 1312.

If the result of the determination at step 1308 is positive, the search server 106, at step 1314, presents a navigation bar 1208 to the user that includes links to the other portions. The search server 106, at step 1316, determines if a link has been selected. If the result of this determination is negative, the search server 106 continues to determine if a link has been selected. If the result of this determination is positive, the search server 106, at step 1318, dynamically presents the web page to the user at the portion associated with the link. The control flow then exits at step 1320. It should be noted that steps 1314, 1316, and 1318 are optional.

One advantage of the present invention is that a user is able to search for questions or other information by entering search keywords and have the search results displayed by an anchored search result display to the user. In this way, the user does not have to search throughout the web page to locate the searched for items. This provides significant time savings and reduced manual labor for the user.

For example, a user can enter search keywords into a question search engine and have a list of questions associated with those search keywords displayed. A user who is looking for questions associated with specific search keywords, and/or answers to a specific question does not have to sort through hundreds or thousands of web pages in order to find questions. Another advantage of one embodiment of the present invention is that the list of questions returned to the user can be displayed sorted by relevance, thereby increasing the likelihood of the user finding more relevant questions, and hence useful answers in the least amount of time.

Another advantage is that based on the entered keywords, a list of news stories including questions associated with the keywords can be displayed to the user. In one embodiment, the most relevant question associated with the user's entered keywords can be displayed as the headline of the news story. This allows a user to select a news story that is more relevant to the entered keyword(s).

As discussed above, an advantage of one embodiment of the present invention is that a portion of a web page comprising searched for terms is dynamically presented to a user. For example, a user can be displayed a list of search results based on entered search keywords. When the user selects a search result the corresponding web page is presented to the user at the portion of the web page comprising the searched for terms. Therefore, a user does not have to search through a web page for the desired searched terms.

The present invention can be realized in hardware, software, or a combination of hardware and software. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

Embodiments of the invention can be implemented as a program product for use with a computer system such as, for example, the computing environment shown in FIG. 1 and described herein. The program(s) of the program product defines functions of the embodiments (including the methods described herein) and can be contained on a variety of computer readable media. Illustrative computer readable medium include, but are not limited to: (i) information permanently stored on non-writable storage medium (e.g., read-only memory devices within a computer such as CD-ROM disk readable by a CD-ROM drive); (ii) alterable information stored on writable storage medium (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such computer readable media, when carrying computer-readable instructions that direct the functions of the present invention, represent embodiments of the present invention.

In general, the routines executed to implement the embodiments of the present invention, whether implemented as part of an operating system or a specific application, component, program, module, object or sequence of instructions may be referred to herein as a “program.” The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It is also clear that given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.) It should be appreciated that the invention is not limited to the specific organization and allocation or program functionality described herein.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method, with an information processing system, for dynamically presenting a portion of web content including a set of searched for keywords to a user, the method comprising:
displaying a set of search results to a user, wherein the set of search results are associated with at least one search keyword provided by the user, and wherein each search result in the set of search results is associated with a search target;
receiving, from the user, a selection of one of the search results; and
presenting, in response to receiving the selection, a portion of the search target associated with the selected search result at a portion of the search target comprising the at least one search keyword.

2. The method of claim 1, further comprising:
analyzing each search result in the set of search results; and
identifying, in response to the analyzing, at least one portion of the search target associated with each of the search results, respectively, that comprises the at least one search keyword.

3. The method of claim 2, further comprising:
determining, in response to the identifying, that a plurality of portions of the search target include the at least one search term; and
presenting, in addition to the presented portion of the search target comprising the at least one search keyword, a set of links each link associated with an additional portion of the search target including the at least one search keyword.

4. The method of claim 3, further comprising:
receiving, from the user, a selection of a link in the set of links; and
presenting, in response to the receiving, the additional portion of the search target associated with the link to the user.

5. The method of claim 1, wherein the search target comprises at least one of:
a title of a web page;
a description of a web page;
a summary of a web page;
a web page; and
a website.

6. The method of claim 1, wherein a size of the portion of the search target that is displayed to a user is predefined by the user.

7. The method of claim 1, wherein a size of the portion of the search target that is displayed to a user is based on a resolution of the user's display.

8. An information processing system for presenting search results to a user, the information processing system comprising:
a processor;
memory, communicatively coupled with the processor;
a user interface, communicatively coupled with the processor and memory; and
a search engine; communicatively coupled with the processor and the user interface, adapted to:
displaying a set of search results to a user, wherein the set of search results are associated with at least one search keyword provided by the user, and wherein each search result in the set of search results is associated with a search target;
receiving, from the user, a selection of one of the search results; and
presenting, in response to receiving the selection, a portion of the search target associated with the selected search result and wherein the portion of the search target comprises the at least one search keyword.

9. The information processing system of claim 8, wherein the search engine is further adapted to:
analyzing each search result in the set of search results; and
identifying, in response to the analyzing, at least one portion of the search target associated with each of the search results, respectively, that comprises the at least one search keyword.

10. The information processing system of claim 9, wherein the search engine is further adapted to:
determining, in response to the identifying, that a plurality of portions of the search target include the at least one search term; and
presenting to a user, in addition to presenting the portion of the search target comprising the at least one search keyword, a set of links each link associated with an additional portion of the search target including the at least one search keyword.

11. The information processing system of claim 10, wherein the search engine is further adapted to:
receiving, from the user, a selection of a link in the set of links; and
presenting to the user, in response to the receiving, the additional portion of the search target associated with the link to the user.

12. The information processing system of claim 8, wherein the presenting comprises:
displaying, in response to receiving the selection, a portion of the search target associated with the selected search result and wherein the portion of the search target comprises the at least one search keyword.

13. The information processing system of claim 12, wherein a size of the portion of the search target that is displayed is based on a resolution of a user's display.

14. The information processing system of claim 8, wherein a size of the portion of the search target that is presented is predefined by a user of the information processing system.

15. A search server for displaying web content search results to users, the web search server comprising:
a network interface for communicatively coupling the web search server via a network with users;
a processor;
memory;
a user display interface for displaying web content search results to the users; and
a web search engine, communicatively coupled with the network interface, the processor, the memory, and the user display interface, the web search engine being adapted to:
displaying a set of search results to at least one user, wherein the set of search results are associated with at least one search keyword provided by the at least one user, and wherein each search result in the set of search results is associated with a search target;
receiving, from the at least one user, a selection of one of the search results; and
displaying, in response to receiving the selection, a portion of the search target associated with the selected search result, wherein the displayed portion comprises the at least one search keyword.

16. The search server of claim 15, wherein the search engine is further adapted to:
analyzing each search result in the set of search results; and
displaying, in response to the analyzing, at least one portion of the search target associated with each of the search results, respectively, that comprises the at least one search keyword.

17. The search server of claim 15, wherein the search engine is further adapted to:
determining, in response to the identifying, that a plurality of portions of the search target include the at least one search term; and
displaying, in addition to displaying the portion of the search target comprising the at least one search keyword, a set of links each link associated with an additional portion of the search target including the at least one search keyword.

18. The search server of claim 17, wherein the search engine is further adapted to:
receiving, from the at least one user, a selection of a link in the set of links; and
displaying to the at least one user, in response to the receiving, the additional portion of the search target associated with the link.

19. The search server of claim 15, wherein a size of the portion of the search target that is displayed is based on a resolution of a display of the at least one user.
